(19) United States
(12) Patent Application Publication
(10) Pub. No.: US 2009/0157499 A1
(43) Pub. Date: Jun. 18, 2009

(54) AUTOMATIC SPLICES FOR TARGETED ADVERTISEMENTS

(75) Inventors: Ruston Panabaker, Redmond, WA (US); John C. Krumm, Redmond, WA (US); Jeffrey D. Couckuyt, Bothell, WA (US); Ivan J. Tashev, Kirkland, WA (US); Michael Lewis Seltzer, Seattle, WA (US); Neil W. Black, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/957,206

(22) Filed: Dec. 14, 2007

(51) Int. Cl. G06F 19/00

(52) U.S. Cl. 705/14

(57) ABSTRACT

Commonly targeted advertising is used to attract a specific demographic towards a particular product and/or service. An advertisement can be presented over a vehicle radio that relate to a route while a user is driving. Advertisements can be directed to a user, including such information as a user name, a user's destination, contextual information, etc. Advertisements can be masked to appear as thought they are part of a standard program; for instance, a normal radio advertiser's voice can be used.

### CROSS-REFERENCE

This application relates to U.S. patent application draft with Attorney Docket No. MSFTP2086US entitled “ROUTE MONETIZATION”.

This application relates to U.S. patent application draft with Attorney Docket No. MSFTP2087US entitled “FEDERATED ROUTE PRODUCTION”.

This application relates to U.S. patent application draft with Attorney Docket No. MSFTP2088US entitled “DESTINATION AUCTIONED THROUGH BUSINESS OF INTEREST”.

This application relates to U.S. patent application draft with Attorney Docket No. MSFTP2089US entitled “GENERATIONAL INTELLIGENT NAVIGATION MANIPULATION”.

This application relates to U.S. patent application draft with Attorney Docket No. MSFTP2090US entitled “SOCIAL NETWORK BASED ROUTES”.

This application relates to U.S. patent application draft with Attorney Docket No. MSFTP2091US entitled “ROUTE TRANSFER BETWEEN DEVICES”.

This application relates to U.S. patent application draft with Attorney Docket No. MSFTP2092US entitled “ADDITIONAL CONTENT BASED ON INTENDED TRAVEL DESTINATION”.

This application relates to U.S. patent application draft with Attorney Docket No. MSFTP2094US entitled “PEDESTRIAN ROUTE PRODUCTION”.

This application relates to U.S. patent application draft with Attorney Docket No. MSFTP2095US entitled “ROUTE GENERATION BASED UPON ACTIVITY CRITERIA”.

### TECHNICAL FIELD

The subject specification relates generally to traffic routing and in particular to disclosure of targeted advertising related to user travel upon a route through a programming broadcast.

### BACKGROUND

Computer-driven route planning applications are utilized to aid users in locating points of interest, such as particular buildings, addresses, and the like. Additionally, in several existent commercial applications, users can vary a zoom level, thereby enabling variation of context and detail as a zoom level of a map is altered. For example, as a user zooms in on a particular location, details such as names of local roads, identification and location of police and fire stations, identification and location of public services, such as libraries, museums, and the like can be provided to the user. When zooming out, the user can glean information from the map such as location of the point of interest within a city, state, and/or country, proximity of the point of interest to major freeways, proximity of the point of interest to a specific city, and the like. In some applications, satellite images can be utilized to provide users with additional detail regarding a particular geographic location or region. For example, a prospective purchaser of a house can obtain an overhead satellite image of the house, thereby enabling the prospective purchaser to view lines of occupation, proximity of the house to other adjacent houses, and other information that may be pertinent to the user.

Furthermore, conventional computer-implemented mapping applications often include route-planning applications that can be utilized to provide users with directions between different locations. Pursuant to an example, a user can provide a route planning application with a beginning point of travel and an end point of travel (e.g., beginning and ending addresses). The route planning application can include or utilize representations of roads and intersections and one or more algorithms to output a suggested route of travel. These algorithms can output routes depending upon user-selected parameters. For instance, a commercial route planning application can include a check box that enables a user to specify that she wishes to avoid highways. Similarly, a user can inform the route planning application that she wishes to travel on a shortest route or a route that takes a least amount of time (as determined by underlying algorithms). Over the last several years, individuals have grown to rely increasingly on route planning applications to aid them in everything from locating a friend's house to planning cross-country road trips.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Conventional radio advertisements can be directed toward a user's travel since many individuals listen to a radio broadcast while operating a vehicle. For instance, a relatively large number of advertisements can be played that relate to fuel stations since many advertisers presume users operate vehicles that operate with fuel. While targeted advertising can be more effective (e.g., advertising fuel to people in a situation that readily need fuel), classical systems do not create enough of a user-specific message during travel.

The disclosed innovation allows targeted advertising to be presented to a user, commonly though an automotive radio where the advertisements relate to travel. The advertisements can be user-specific, such as addressing the user by name, using a familiar voice, pointing out how a product can specifically benefit a user, etc. A break in a program is recognized or anticipated and a user-specific detail (e.g., related to an available highway exit) is spliced into the program. An advertisement intended to be played at a program break can be suppressed and the user-specific detail can be disclosed.

Advertisement development has focused on improving advertisements to mass audiences. A large amount of expenditures are made to track programs engaged in by users - for instance, television observers can employ ratings and market share across different groups (e.g., gender, age, ethnicity, etc.) to determine viewer demographics. Based upon the observed results, advertisements are tailored to reach the demographic (e.g., for men, conveying a message that using a product will increase desirability of a user toward women). Since market trends have dominated improvement of advertisement for mass audiences, it appears illogical to focus on improving advertisements on an individual basis. However, unexpected results are likely to occur that increase a user's likelihood in purchasing a product based upon a user-specific advertisement.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative system for disclosing a user-specific detail in accordance with an aspect of the subject specification.

FIG. 2 illustrates a representative system for disclosing a user-specific detail with a detailed example recognition component in accordance with an aspect of the subject specification.

FIG. 3 illustrates a representative system for disclosing a user-specific detail with a detailed example splice component in accordance with an aspect of the subject specification.

FIG. 4 illustrates a representative system for disclosing a user-specific detail that can create and disclose details in accordance with an aspect of the subject specification.

FIG. 5 illustrates a representative assembly component in accordance with an aspect of the subject specification.

FIG. 6 illustrates a representative user-detail presentment methodology in accordance with an aspect of the subject specification.

FIG. 7 illustrates a representative break anticipate methodology in accordance with an aspect of the subject specification.

FIG. 8 illustrates a representative user-specific detail selection methodology in accordance with an aspect of the subject specification.

FIG. 9 illustrates an example of a schematic block diagram of a computing environment in accordance with the subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Determinations or inferences made by components and the like in the subject specification can be practiced through utilization of artificial intelligence techniques.

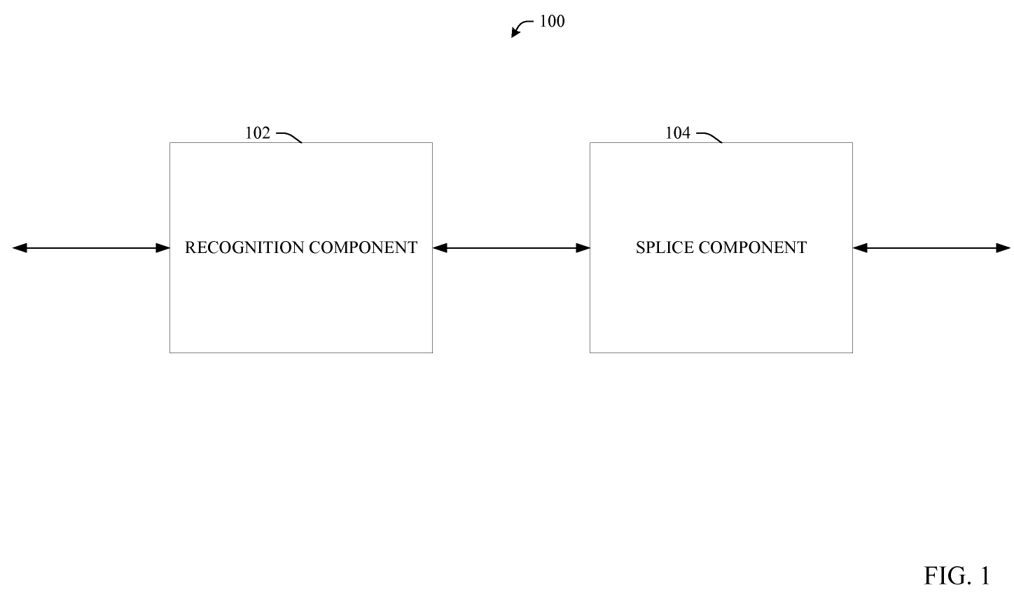

Now referring to FIG. 1, a system 100 is disclosed that allows details to be spliced into a program that relate to a user's travel. Commonly, a user listens to a radio while operating a vehicle (e.g., automobile, motorcycle, bicycle, airplane, helicopter, motorboat, self-balancing transportation device, etc.), jogging, or traveling by foot. Radio programs generally include content such as music, commentary, debate, live events, and the like, where the content is segmented through breaks. During the breaks details are disclosed, typically commercial details (e.g., advertisements) intended to convey a message to a user (e.g., to sell a product, station identification, etc.). The disclosed innovation allows user-specific details to be presented to the user, thus likely increasing message effectiveness. It is to be appreciated that the disclosed innovation is not limited to individuals traveling via a vehicle; for instance, a targeted advertisement can be played to a pedestrian listening to a portable radio.

Monitoring of a program broadcast (e.g., radio program, television show, online video stream, etc.) can be performed by a recognition component 102 can process a break in a program broadcast (e.g., the recognition component 102 can break into a program broadcast). Processing a break can include discovering signs that a break is coming, making an inference that a break will take place, determining when a break initializes, identifying a break, pausing the program broadcast and thus causing a break (e.g., though retention of the program broadcast in storage), etc. For instance, many television and radio broadcasters use markers to indicate a start of an advertising spot. The recognition component 102 can establish existence of a marker in order to process a break (e.g., identify a break). A message can transfer to a splice component 104 that a break is anticipated to take place and/or a break has begun.

The splice component 104 can integrate user-specific travel information (e.g., information related to navigation of a user upon a route) upon the break (e.g., an identified break, a created break, and the like). A user-specific travel detail can be obtained from a database by the splice component 104 as well as be transferred from an auxiliary location. A detail that is initially to be disclosed to a user is suppressed and the user-specific detail is presented over the suppressed detail. However, other embodiments can be practiced; for instance, a conventional advertisement can be deleted as opposed to suppressed and the user-specific detail is placed in the deleted area. According to one embodiment, the splice component 104 can implement masking features, such that a user is not readily aware a detail is specific to her. For example, a detail can sound similar to a general advertisement; however, a ‘nearest location’ in the advertisement is disclosed that is physically nearest to a user when the user hears the advertisement.

The user-specific travel information can relate to a single user as well as to a group of users. For instance, a public display at a popular tourist destination can be disclosing a video concerning local history. Analysis of individuals watching the video can take place and based upon results of the analysis, a detail related to travel of at least a part of a group of individuals watching the video can be disclosed. For instance, there can be an advertisement for a coffee shop nearby in a native language spoken by a majority of individuals watching the video instance. The individuals can alter their route based upon the advertisement such that they visit the coffee shop.

The following is an illustrative example for operation of the system 100 as part of a vehicle. A user can be driving along a route to an intended destination using a navigation system while listening to a radio program. A marker in a programming stream can indicate the start of a commercial break of a specific duration. A notice transfers to the splice component 104 stating a break is anticipated to take place and an advertisement should be presented. For instance, an advertisement can be a celebrity endorsing an athletic shoe. The splice component 104 can place a detail that is directed to the user into a spot created by detail suppression (e.g., suppress a national advertisement with a user-specific advertisement).

An initial advertisement for the shoe can be ‘Buy the new Turbo Sneaker. The soles are made from a rubber compound initially designed for the space program. It will make your run faster, jump higher, and let you dominate over the competition.’ The splice component 104 can suppress the initial advertisement with an advertisement for the same shoe, but directed toward the user. The user-specific advertisement can recite ‘John, with the new Turbo Sneaker, you could score thirty points against Valley High this Friday. Turbo Sneakers are available at Shoe Store X located at the same highway exit as your intended destination.’ In addition to having the message tailored to the user, contextual factors can be used to direct the advertisement toward the user. For instance, the voice of an announcer can change from a nationally renowned spokesperson to a local representative that has more identification to a user (e.g., both the local representative and the user grew up in the same neighborhood). It is to be appreciated that a user-specific detail does not need to be related to a detail that is suppressed, deleted, etc. An initial advertisement can be for the athletic shoe while a replaced detail concerns a weather forecast.

While the above example discloses an alteration for a singular product, the disclosed innovation can also allow a detail to be disclosed on a completely different product. For example, the same initial advertisement can be intended for disclosure. The splice component 104 can suppress the initial advertisement with a different detail. For instance “If you take an about two minutes detour, then there is a coffee shop that is home of the one dollar espresso.” The splice component 104 can additionally suppress a program portion (e.g., pause a radio program broadcast) to provide a user additional content on how to reach the coffee shop (e.g., “Take a right on Thomas Street, the coffee shop is on the corner of Thomas Street and 23^{rd}” when a user is near Thomas Street). The program broadcast can be un-paused and the program can be played over other program breaks (e.g., through recorded playback) to compensate for lost time.

Commonly, the user-specific travel information integrated upon the break relates to an intended destination, route waypoint, route metadata, or a combination thereof. With the intended destination, a detail can be disclosed that instructs a user by name to purchase a product at a store she intends to visit. Concerning a route waypoint, a destination along a route (e.g., a shop at an unexpected highway exit) not expected to be visited can be suggested to a user. Route metadata allows information to be presented that relates to a direction set. For instance, if it is raining outside of a vehicle while a user is driving, then a notice can be disclosed to a user where an umbrella is located within a vehicle.

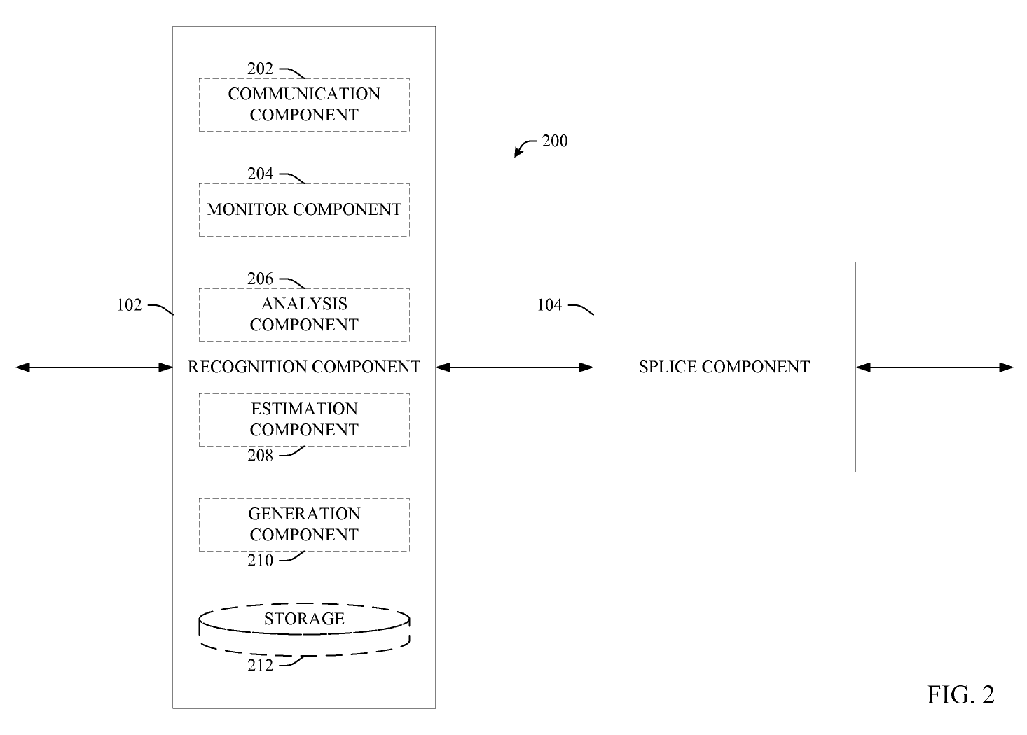

Now referring to FIG. 2, a system 200 is disclosed for integrating a user-specific detail with an example comprehensive recognition component 102. A communication component 202 can engage with other devices to transfer information, such as to send a request for information. Operation can take place wirelessly, in a hard-wired manner, employment of security technology (e.g., encryption), etc. Moreover, the communication component 202 can utilize various protective features, such as performing a virus scan on obtained data and blocking information that is positive for a virus.

The communication component 202 can link with a disclosure component (e.g., a radio), where the link enables a monitor component 204 to observe a program broadcast. The monitor component 204 can ascertain characteristics of the program broadcast that can be used to determine a break. For instance, the monitor component 204 can learn language of a program (e.g., ‘to be continued’), use a timing circuit (e.g., a program broadcast has not had a break in a relatively long time), receive a signal from a broadcaster that a break is coming, etc. Additionally, the monitor component 204 can observe multiple programs at one time (e.g., observe a program a user is listening to as well as other broadcasted programs over a frequency range). In a further embodiment, the system 200 can take greater control over a program broadcast. For instance, if a break has not occurred in a relatively long time (e.g., as tracked by the monitor component 204) or a relevant location is being approached (e.g., a favorite coffee shop), then the system can pause a program to disclose a travel related commercial detail. Once the detail is disclosed, the program can continue at an exact point paused for the commercial break.

Information gathered from use of the communication component 202, observations made by the monitor component 204, and data from other components can be processed by an analysis component 206. The analysis component 206 can learn information about a program and make determinations based upon the learning. In one example, the monitor component 204 can observe a weekly program for multiple instance and learn information concerning the program (e.g., after an intro portion, there is historically an about two minute break). The analysis component 206 can learn that a break takes place after the intro and instruct other components to perform pre-processing to increase operation speed.

Based at least in part upon data gathered by the monitor component 204, an estimation component 208 can anticipate a break. The estimation component 208 can infer and/or determine when a break is to take place by examining monitored information. For instance, the estimation component 208 can obtain data that a program broadcast will have an about two minute long break for each about eight minute program portion. The estimation component 208 can use timing information (e.g., about seven minutes and fifty seconds of a program portion has passed) with learned data to anticipate the break.

Based upon gathered information, a generation component 210 can produce a user profile, broadcaster profile, program profile, and the like. Based upon learned information, profiles can be created and retained in storage 212. Determinations can be made concerning what information should be placed in a profile and how a profile is to be organized. Moreover, the generation component 210 can determine when a profile should be created as well as when to eliminate a profile (e.g., if a program has not been listened to in about six months, then a related program profile is deleted to save storage space).

Storage 212 can be arranged in a number of different configurations, including as random access memory, battery-backed memory, hard disk drives, magnetic tape, etc. Various features can be implemented upon storage, such as compression and automatic back up (e.g., use of a Redundant Array of Independent Drives configuration). In addition, storage 212 can employ various techniques to improve effectiveness, such as compression/decompression capabilities. The recognition component 102 can produce an output (e.g., a notice of an identified break) consumed by a splice component 104 that integrates user-specific information upon the identified break.

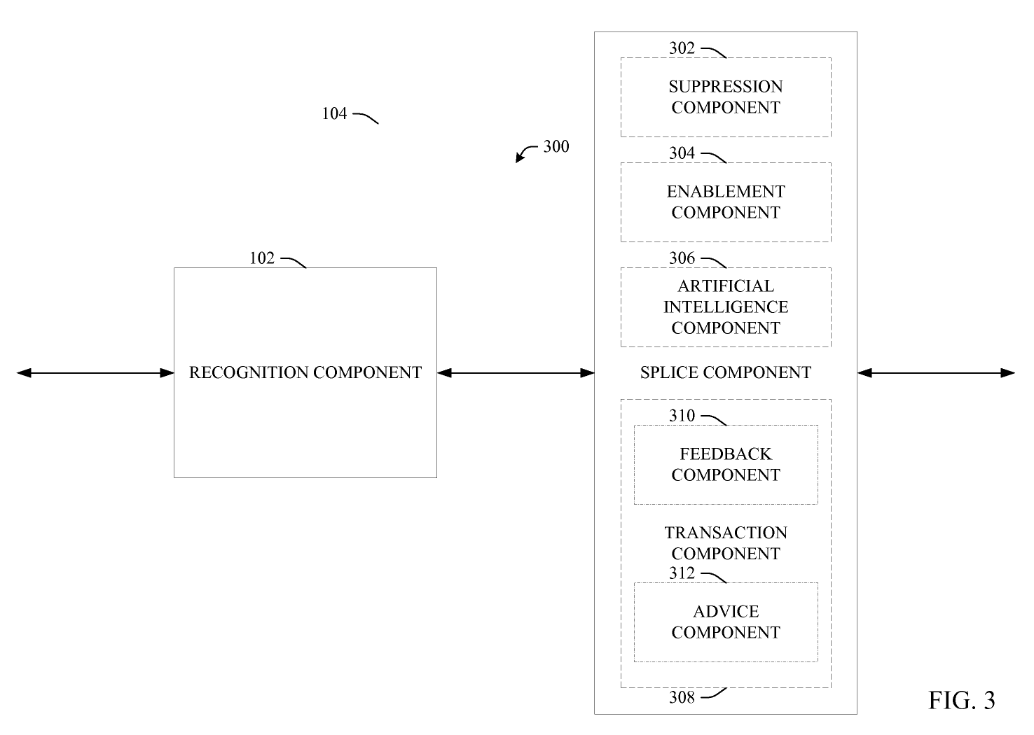

Now referring to FIG. 3, a system 300 is disclosed for integrating a user-specific detail with an example comprehensive splice component 104 that integrated information upon a break identified by a recognition component 102. Commonly, a program broadcast supplies standard advertising to be presented during breaks. A suppression component 302 can stop a standard advertisement from being presented to a user. Classic operation of the suppression component 302 stifles the standard advertisement (e.g., mutes the advertisement during a radio broadcast), deletes a standard advertisement before reaching a disclosure component, etc. The suppression component 302 can configure to filter a general detail through an assembly component that modifies the general detail into a specific detail.

With an advertisement being suppressed, an enablement component 304 can allow a user-specific detail to be disclosed. The enablement component 304 can send a signal to a disclosure component that a user-specific detail should be presented over a broadcaster provided detail. In addition, the enablement component 304 can activate an assembly component that can construct and/or modify a general detail into a user-specific detail.

Various determinations and or inferences related to the break identification, information integration, or other operations disclosed in the subject specification can be made by an artificial intelligence component 306. For example, the artificial intelligence component 306 can determine a time in which to integrate a user-specific detail. Moreover, the artificial intelligence component 306 can be used to infer when a break is anticipated to take place.

Artificial intelligence component 306 can employ one of numerous methodologies for learning from data and then drawing inferences and/or creating making determinations related to applying a service (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems.

According to one embodiment, a broadcaster sends several advertisements for disclosure during a break, where one advertisement is to be presented. The artificial intelligence component 306 can determine an advertisement that is highly user-specific (e.g., the most user-specific). The suppression component 302 can delete all but about one advertisement and the enablement component 304 can transfer the remaining advertisement to a disclosure component.

Commonly, a relatively large amount of money can be paid to disclose a detail such as an advertisement. Since an alteration to an intended disclosure takes place, a transaction component 308 can perform a reward operation (e.g., fiscal function) in relation to operation of the system 300. In one example, if a general advertisement is suppressed to disclose a user-specific advertisement for a different product, then compensation can be paid to a broadcaster and/or general advertiser (e.g., paid by the manufacturer of the different product). In an alternative implementation, if the system 300 enhances an advertisement's effectiveness, then an advertiser can pay a user account, a manufacturer of the system 300, etc. for a privilege of having an advertisement enhanced.

Moreover, a reward operation can take place in relation to user response to a commercial detail (e.g., presented with a route). For example, an advertisement can be played that a user should stop at a highway exit for a cup of coffee. If the user takes the exit, buys the cup of coffee, buys a different item, etc., then payments of varying amounts can be made to an advertisement hosting service.

In addition, the reward operation can take place in relation to user response to a commercial detail. For example, an advertisement can be played that a user should stop at a highway vehicle for a cup of coffee. If the user takes the exit, buys the cup of coffee, buys a different item, etc., then varying amounts of information can be paid to an advertisement hosting service. Moreover, the transaction component 308 can employ a feedback component 310 that communicates to an entity (e.g., an advertiser) how a user responded to a disclosed detail. Thus, the feedback component 310 can communicate a user response to a presentation of the user-specific travel-information. Additionally, an advice component 312 can transmit a suggestion to an entity on how to make a detail more likely to garner a particular response from the user. For instance, user response to other disclosed details can be analyzed to create the suggestion.

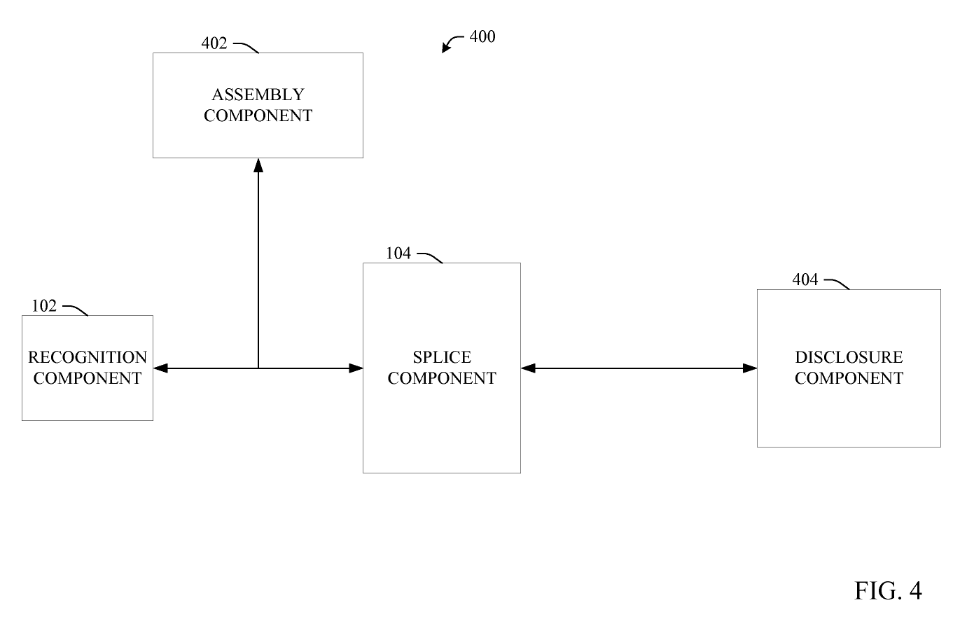

Now referring to FIG. 4, a system 400 can be used to create a user-specific detail and display the user-specific detail. A recognition component 102 can identify a break in a program broadcast utilizing aspects disclosed throughout the subject specification. The recognition component 102 can transfer a signal that a break is to take place as well as metadata related to the break (e.g., estimated length).

An assembly component 402 can produce a user-specific detail (e.g., advertisement) based upon data outputted by the recognition component 102 as well as from auxiliary sources. Initiation of the assembly component 402 can occur upon identification of a break by the recognition component 102. A detail provided by a broadcaster can be obtained by the assembly component 402 and altered to become a user-specific detail. In an alternate embodiment, the assembly component 402 constructs a new user-specific detail; the newly constructed detail can be based upon profile information, as a retained template, etc.

Output of the assembly component 402 can be utilized by a splice component 104 that integrates user-specific information upon the identified break. A user-specific detail integrated into an identified break is commonly presented through a disclosure component 404. A disclosure component 404 allows a user to appreciate a detail; thus, the disclosure component 404 can present the program broadcast or the user-specific travel information. A non-exhaustive list of disclosure components include a display screen, touch screen, radio (e.g., frequency modulation, amplitude modulation, satellite, etc.), virtual reality environment, Braille production system, printer, etc. In addition, the disclosure component 404 can present information in multiple formats, such as showing a video with audio capabilities. The disclosure component 404 can have altering capabilities that modify the user-specific detail. For instance, an integrated detail can be in color, while the disclosure component 404 cannot display color. A modification can be made upon the detail such that it converts from color to black-and-white. Other modifications can take place, such as taking a document for display and converting the document into audible sound.

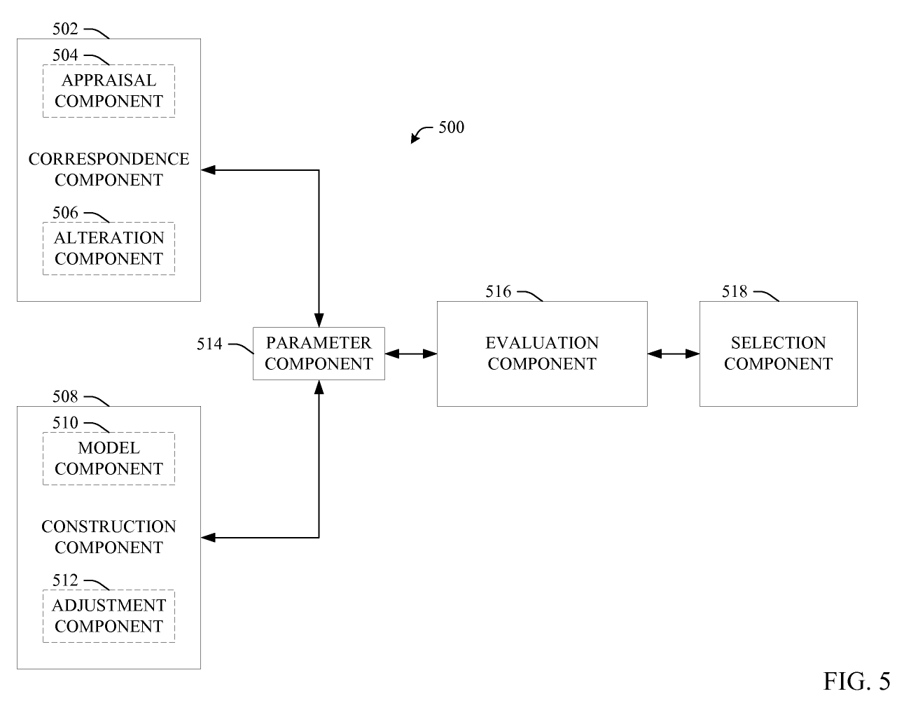

Now referring to FIG. 5, an example assembly component 402 that produces a user-specific detail is disclosed. Two common manners used to produce a user-specific detail are to alter an existing detail or create a new detail (e.g., though utilization of a template). An existing detail can be collected through utilization of a correspondence component 502. A correspondence component 502 can engage with other devices to transfer information. Operation can take place wirelessly, in a hard-wired manner, employment of security technology (e.g., encryption), etc. Moreover, the correspondence component 502 can utilize various protective features, such as performing a virus scan on obtained data and blocking information that is positive for a virus.

An appraisal component 504 can evaluate a provided detail (e.g., provided from a broadcaster) and determine how to modify the detail to produce a user-specific detail. This commonly takes place when a detail (e.g., advertisement) is to be enhanced to increase appeal to the user. The appraisal component 504 can operate as a means for appraising a non-user specific detail. The appraisal result is used to alter the non-user-specific detail into a user-specific detail

The evaluation results can be used to change the provided detail through use of an alteration component 506. For instance, a detail can be for a new sandwich at a fast-food restaurant; the alteration component 506 can determine a nearest restaurant franchise to a vehicle operating the system and place directions to the franchise in the user-specific detail. The alteration component 506 can configure as a comprising means for altering a non-user-specific detail into a user-specific detail. Evaluation can take place upon the altered user-specific detail.

A construction component 508 can be used to build a user-specific detail without use of an original detail. For instance, a notice (e.g., an electronic signal) can be sent to the system 500 that a thunderstorm is approaching an area of a vehicle using the system 500. Based upon the notice, the construction component 508 can build a detail to assist a user through the thunderstorm.

According to one embodiment, a template is used by a model component 510 as a basis for the user-specific detail. The model component 510 can access a template database and a determination is made upon which template should be used in creating a user-specific detail. For instance, a first template can be used for convincing a user to act in a certain manner during an emergency while a supplemental template can communicate information to a user related to the emergency. Determining an appropriate template can be performed by the model component. The model component 510 can operate as a means for designating a template for use in constructing the user-specific detail.

A designated template can be copied into storage and modifications can be made through use of an adjustment component 512. For instance, a template can be for an audio presentation that if about fifteen seconds long; however, an identified break can be anticipated to last about ten seconds. The adjustment component 512 can change the template to disclose information in a designated amount of time. The adjustment component 512 can implement as a means for adjusting a template to create a user-specific detail.

A user-specific detail can be processed by a parameter component 514 to make the presentment of the detail more beneficial. For instance, a user-specific detail can be instructions on how to proceed in an emergency. The parameter component 514 can modify a voice of the presentation to be of a person familiar to a user. For example, if the system 500 is implemented in a vehicle, then the parameter component 514 can monitor conversations that take place between occupants of the vehicle (e.g., a mother, her husband, children, etc.) and store conversation metadata (e.g., a husband's voice, nicknames used, etc.). A heavy rainstorm can occur while an aunt is driving a vehicle of the mother while transporting a child of the mother (e.g., niece of the aunt). The parameter component 514 can alter the user-specific detail to be played as the mother's voice and to refer to the child by a nickname (e.g., “Aunt Betty and Princess should take Main Street as opposed to the highway.”) A heavy rainstorm can be a frightening experience for a child and playing instructions (e.g., a command to drive slowly to be safer during the storm) in the mother's voice can aid in calming the child. The parameter component 514 can function as a means for adjusting a template to create a user-specific detail (e.g., detail produced by the correspondence component 502, detail outputted from the construction component 508, etc.).

A processed user-specific detail can be analyzed by an evaluation component 516 to determine effectiveness of the detail. For instance, the evaluation component 516 can compare characteristics of the detail against user history. If in several previous disclosures the user did not act upon a detail spoken with a voice of a spouse, then the evaluation component can infer a similar detail will not be positively received by the user. In an alternate embodiment, the evaluation component 516 operates prior to the parameter component 514 to instruct the parameter component 514 on how to enhance a user-specific detail. The evaluation component 516 can be implemented as a means for evaluating at least one user-specific detail.

Evaluation results of about one or more user-specific details can be processed by a selection component 518 that determines a detail for disclosure. According to one embodiment, the selection component 518 chooses a detail from a group of user-specific details; however, selection can be between disclosing a user-specific detail and a non-user-specific detail. The assembly component 402 can alter operation based upon results of the selection component 518. For example, if a detail constructed from a template is rarely selected, then the model component 510 can limit use of the template. The selection component 518 can function as a means for selecting a user-specific detail related to a user route for presentment during a program broadcast break based upon the evaluation result.

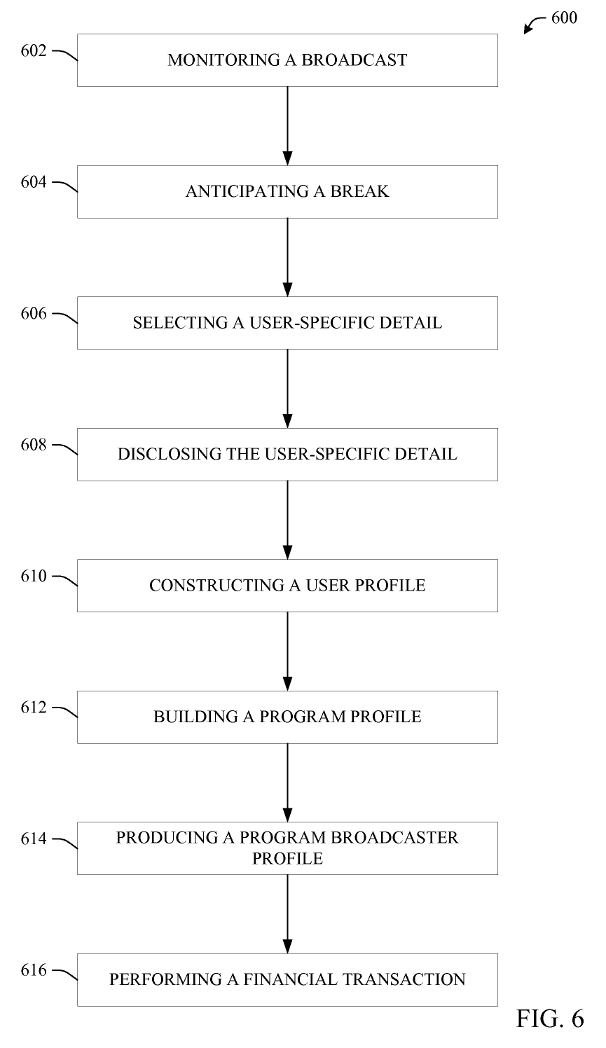

Now referring to FIG. 6, an example methodology 600 is disclosed for performing operations in conjunction with a user-specific detail related to a route associated with a user (e.g., a route the user will travel upon, has traveled upon, is currently traveling upon, etc.). At block 602, a broadcast can be monitored, where the monitoring results can be used to anticipate a break. Monitoring can include timing a broadcast, observing language of a broadcast, and the like.

Event 604 allows for a break of a program broadcast to be anticipated based upon various determinations. Event 604 includes anticipating a break in a broadcast of a program relayed while a user is in transit (e.g., traveling along a route). Anticipation can take place in various manners ranging from overt communications to detailed probability analysis. For instance, a broadcast can send a signal (e.g., marker) that a break is about to take place and event 604 can read the signal.

Since a break is anticipated, action 606 enables selection of a user-specific detail that is to be presented to a user. Action 606 can include selecting a user-specific detail to be presented during the anticipated break, the user-specific detail relates to the transit of the user. A relatively large number of user-specific details can be available for presentment. Action 606 allows details to be selected according to set criteria, including criteria based on relevancy to a user route, estimated effectiveness to a user, financial constraints, etc.

At block 608, a selected user-specific detail is disclosed to the user during the anticipated break. For example, an anticipated break can last for about a minute while a selected detail is to last for about thirty seconds. Disclosure can take place at different times within the minute break, the determination as to what time can be performed according to criteria similar to selection.

A user typically reacts to a disclosed detail (e.g., altering a route, ignoring the detail, etc.) and based upon the reaction, a user profile can be constructed at event 610. The user profile can be used to select a detail at action 606 as well as for other purposes (e.g., determining an amount of money a party is to be paid for detail disclosure). Constructing the user profile can include creating a new profile as well as altering/augmenting an existing profile.

Through monitoring the broadcast at block 602, a program profile can be created at action 612. A program profile can be used in anticipating future breaks. For example, a weekly program can have similar break tendencies each week and these tendencies can be recorded in the program profile. Building the program profile can include creating a new profile as well as altering/augmenting an existing profile.

At block 614, a program broadcaster profile can be produced based upon a monitored broadcast. A broadcaster can have tendencies similar to tendencies related to a program that can be used to anticipate a break. For instance, a user can commonly have a break after a program introduction—history can be stored in the profile and used to determine when another break will take place. Producing the broadcaster profile can include creating a new profile as well as altering/augmenting an existing profile.

At action 616, a financial transaction can take place in relation to other operations of the methodology 600. Upon displaying a user-specific detail, money can transfer between different parties and action 616 allows the transfer to take place. In one embodiment, credits from one account are debited from an advertiser account and moved to a user account.

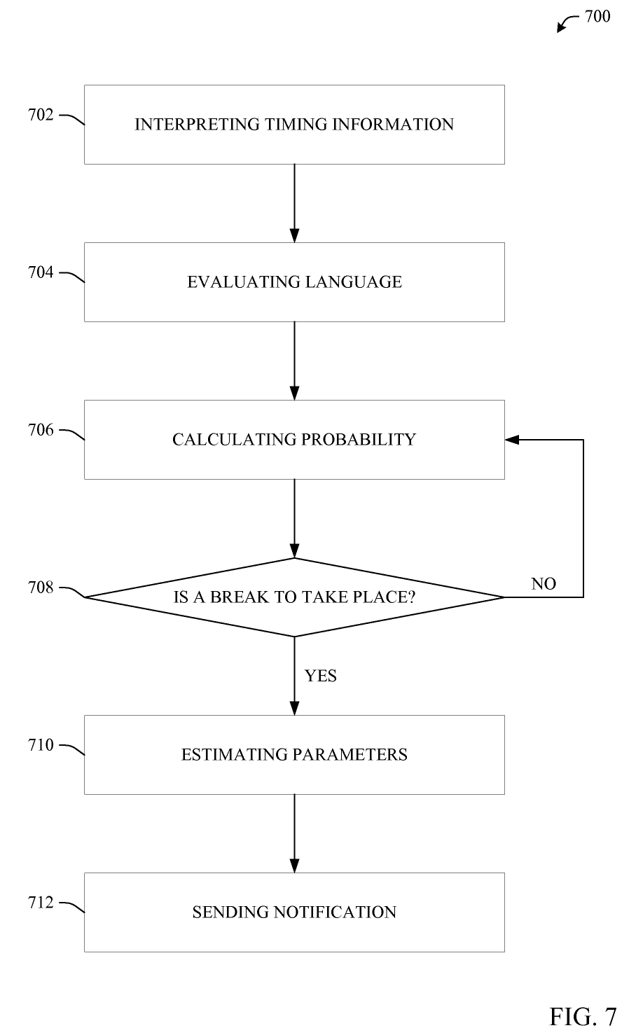

Now referring to FIG. 7, an example methodology 700 is disclosed for anticipating a break in a broadcast of a program relayed while a user is in transit, which can be implemented upon event 604 of FIG. 6. At event 702, timing results are interpreted, where a timing result interpretation can be used to anticipate a break. A comparison can be made between a timing observation and a program profile to determine if historically a break is near.

In addition to timing, language of a program can be evaluated at event 704 to determine when a break is anticipated to take place. Words used by a speaker, tone/inflection of a speaker's voice, music designed to convey mystery, etc. can be used to indicate a break is to take place. Event 704 checks language of a program broadcast to determine if a break is likely to occur.

Based upon gathered information (e.g., timing details, language data, etc.), a probability of a break taking place can be calculated at act 706. For example, previous instances where a program broadcast voice states “we will be right back” have been followed by a break. Act 706 can infer that there is a relatively high probability a break will take place when the above term is used; probability can be represented as percentage likelihood (e.g., about 99.98% certainty a break will take place in the next about five seconds).

A check 708 can occur that determines if a break is to take place. For instance, a comparison can be made with a pre-set threshold—if a probability produced at act 706 is above the threshold, then a break is anticipated and the methodology 700 can continue. If a probability is not at or equal to the threshold, then the methodology 700 can return to act 706 to calculate probabilities.

If a break is anticipated to take place, parameters related to the break are estimated at action 710. Example parameters include length of the break, broadcaster detail conveyance commitments, likelihood a user will tune away from a program broadcast break to a different broadcast not in break, and the like. The parameters can be estimated from information supplied from a broadcaster, from inferences based upon previous engagements, etc.

Notifications related to operation of the methodology 700 can be transferred to various locations at event 712. Included in the notification can be estimated parameters, a break probability, a likelihood the probability will take place, probability metadata, and the like. The notice can be processed and include various features, such as encryption and compression.

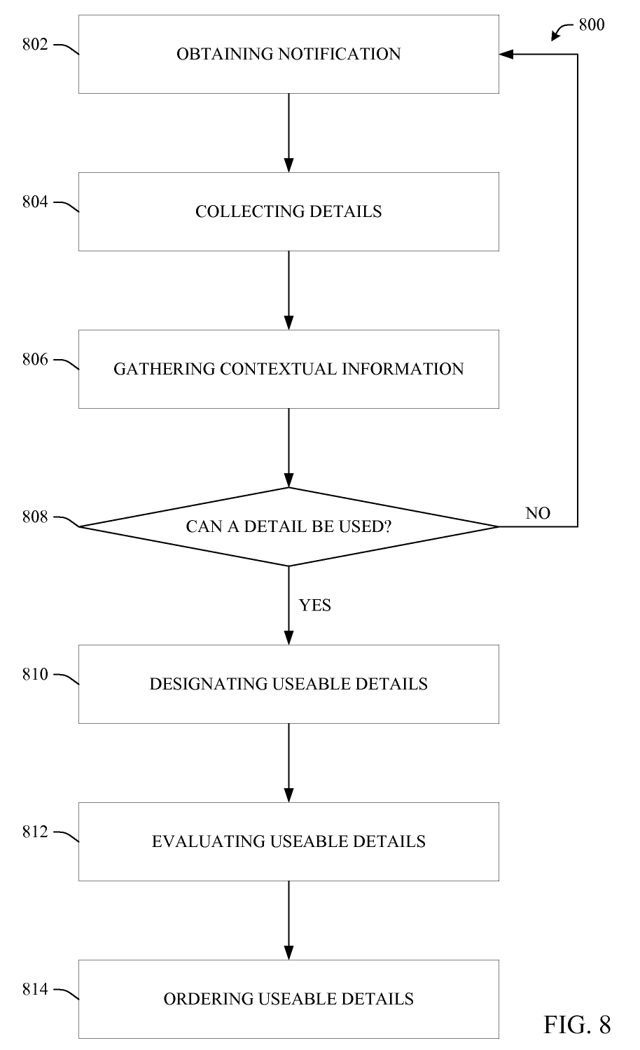

Now referring to FIG. 8, an example methodology 800 is disclosed for selecting a user-specific detail to be presented during the anticipated break, the user-specific detail relates to the transit of the user, which can be implemented upon action 606 of FIG. 6. A notification can be obtained at block 802 that a break is anticipated to take place; according to one embodiment, the notification is produced from event 712.

User-specific details related to user travel (e.g., advertisements for establishments near a user's location) can be collected at event 804 from various locations. A user-specific detail can be provided from competing companies that would like a product highlighted to a user during a program break. A search can be performed in order to locate potential sources of user-specific details, details can be passively collected, etc.

In addition to collecting details, contextual information (e.g., contextual data of the collected details) can be gathered at action 806. Contextual data can include information concerning a user-specific travel detail, information about an anticipated break (e.g., rationale on why a break is expected to take place), etc. Gathered data can be processed and filtered—for instance, veracity of data can be tested and questionable details can be expunged.

A check 808 takes place to determine if a detail is useable. For instance, a user-selected detail can be an about two-minute presentation; however, an anticipated break is about one minute long. The detail likely cannot be used due to its length and the methodology can return to action 802 to obtain a notification of a different break. According to one embodiment, if a useable user-specific detail cannot be located, then a general detail can be disclosed.

Commonly, more then one detail can be collected at event 804 and deemed useable; at block 810, at least some of the collected details (e.g., about one or more details) are designated for presentment. A quality control action can take place to determine if a detail should be disclosed. For example, an advertisement for a movie that requires a viewer to be at least about seventeen years of age should likely not be presented to a fifteen year-old; therefore, the movie advertisement is not designated.

Designated details are evaluated at event 812 in order to obtain relevant characteristic data. Commonly, details are not equal and certain details become superior over others. Event 812 allows for different characteristics of the details to be determined in order to ascertain which details are superior. Processing can take place upon the characteristics, such as associating the characteristics with numbered values to provide a user-specific detail an overall score.

Based upon characteristic data, details to be disclosed can be ordered at action 814. Different criteria can be used to order the details, such as highest priority (e.g., details convey emergency information), money to be provided to a party, etc. Details can be disclosed based upon the order, such that a queue is created and details are disclosed in a set order (e.g., details ranked 1-4 during a first break, details ranked 5-9 in a second break, and so on). In addition, the queue can be continuously updated to as new details are collected and presented.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media. Moreover, while a subset of the subject specification discloses operation of aspects though utilization of a vehicle, it is to be appreciated aspects can be practiced through alternative manners (e.g., walking, swimming, etc.)

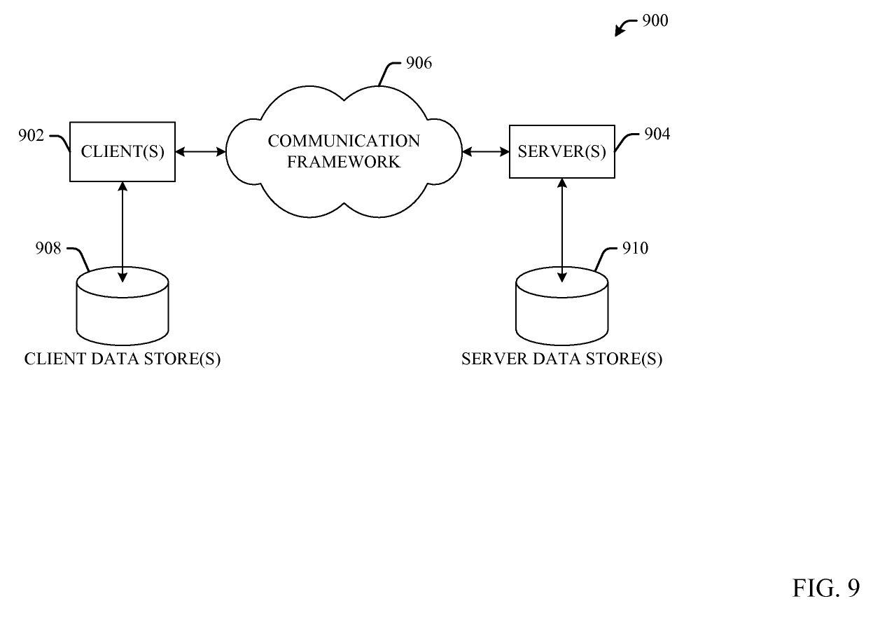

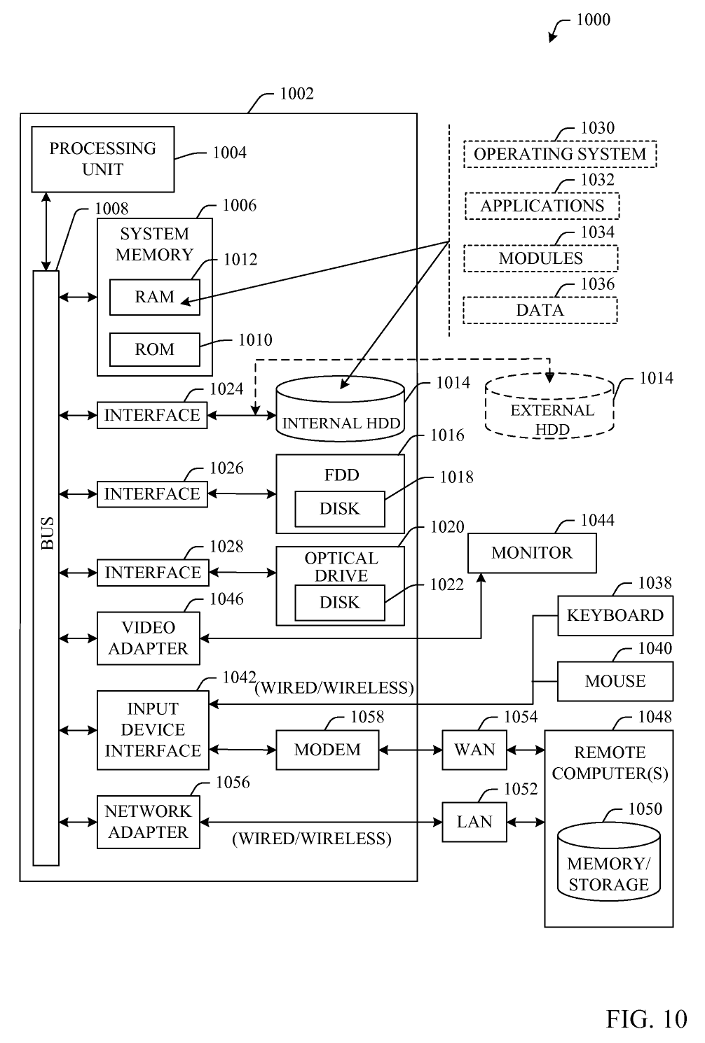

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a recognition component that processes a break in a program broadcast; and
a splice component that integrates user-specific travel information upon the break.

2. The system of claim 1, further comprising a disclosure component that presents the program broadcast or the user-specific travel information.

3. The system of claim 2, further comprising a feedback component that communicates a user response to the presentation of the user-specific travel-information.

4. The system of claim 1, the user-specific travel information is a commercial detail.

5. The system of claim 1, the user-specific travel information relates to an intended destination, route waypoint, route metadata, or a combination thereof.

6. The system of claim 1, further comprising an estimation component that anticipates the break, the recognition component utilizes the anticipation to process the break.

7. The system of claim 1, further comprising a generation component that produces a user profile, broadcaster profile, program profile, or a combination thereof, the integrated user-specific travel information is based upon at least one profile.

8. The system of claim 1, further comprising an assembly component that constructs the user-specific travel information.

9. A method, comprising:
anticipating a break in a broadcast of a program relayed while a user is in transit; and
selecting a user-specific detail to be presented during the anticipated break, the user-specific detail relates to the transit of the user.

10. The method of claim 9, further comprising disclosing the selected user-specific detail during the anticipated break.

11. The method of claim 10, further comprising performing a fiscal operation in conjunction with selecting the user-specific detail or disclosing the selected user-specific detail.

12. The method of claim 9, further comprising constructing a user profile, program profile, program broadcaster profile, or a combination thereof, profile information is used to anticipate the break or to select the user-specific detail.

13. The method of claim 9, further comprising monitoring the program broadcast.

14. A system, comprising:
means for evaluating at least one user-specific detail; and
means for selecting a user-specific detail related to a user route for presentment during a program broadcast break based upon the evaluation result.

15. The system of claim 14, further comprising means for altering a non-user-specific detail into a user-specific detail, the evaluation takes place upon the altered user-specific detail.

16. The system of claim 15, further comprising means for appraising the non-user specific detail, appraisal result is used to alter the non-user-specific detail into the user-specific detail.

17. The system of claim 16, further comprising means for changing the user-specific detail to increase likelihood of being selected.

18. The system of claim 14, further comprising means for adjusting a template to create a user-specific detail, the evaluation takes place upon the created user-specific detail.

19. The system of claim 18, further comprising means for designating the template for use in constructing the user-specific detail.

20. The system of claim 19, further comprising means for changing the user-specific detail to increase likelihood of being selected.
